(19) United States
(12) Patent Application Publication
(10) Pub. No.: US 2011/0016706 A1
(43) Pub. Date: Jan. 27, 2011

(54) RECHARGEABLE BATTERY FABRICATION METHOD

(75) Inventors: Yih-Song JAN, Taipei City (TW); Lun-Chieh He, Taichung City (TW)

Correspondence Address: Muncy, Geissler, Olds & Lowe, PLLC, 4000 Legato Road, Suite 310, FAIRFAX, VA, 22033, US

(73) Assignee: Exa Energy Technology Co., Ltd., Taichung City (TW)

(21) Appl. No.: 12/896,543

(22) Filed: Oct. 1, 2010

Related U.S. Application Data
(63) Continuation-in-part of application No. 11/785,476, filed on Apr. 18, 2007.

(30) Foreign Application Priority Data
Apr. 19, 2006 (TW) 95114004

(51) Int. Cl. H01M 10/00

(52) U.S. Cl. 29/623.1

(57) ABSTRACT

A method of making a rechargeable battery having excellent high current discharge efficiency by preparing a positive pole from an aluminum strip, a negative pole from a copper strip and two isolation membranes first. Then cover the positive pole and the negative pole respectively with a positive pole material film and a negative pole material film so that a bare aluminum zone is defined on the positive pole and a bare copper zone is defined on the negative pole. Then rolling up the positive pole, an isolation membrane, the negative pole and the other isolation membrane, which are orderly arranged in a stack into a multilayer roll so that the bare aluminum zone and the bare copper zone be respectively positioned at top and bottom sides of the multilayer roll. Then weld two conducting poles to the bare aluminum zone and the bare copper zone respectively. Finally, package the multilayer roll in a housing and fill an electrolyte solution in the housing.

### FIELD OF THE INVENTION

The application is a Continuation-In-Part of prior application Ser. No. 11/785,476, the entire contents of which are hereby incorporated by reference.

### BACKGROUND OF THE INVENTION

### Description of the Prior Art

Conventional rechargeable batteries include the so-called roll type battery. A roll type battery has a roll construction formed of a positive pole, a first isolation membrane, a negative pole and a second isolation membrane in order. The positive pole has a conducting pole at its end. The negative pole has a conducting pole at its end. The roll construction is packaged in a housing. Thereafter, an electrolyte is filled in the housing, forming the rechargeable battery.

When a conventional rechargeable battery is used for high current discharge, its discharge efficiency is poor. For example, the discharge efficiency of a 2.0 Ah rechargeable battery is about 50% when discharged at 15 C (30 A) (see line D in FIG. 6), or about zero when discharged at 20 C (40 A) (see line F in FIG. 7). Therefore, how to improve the discharge efficiency of a rechargeable battery during high current discharging has become a research and develop problem in the battery industry.

US 2002/0142211 discloses a roll type battery, in which the positive and negative poles are rolled into a cylindrical shape. Such cylinder structure is disadvantageous in that the collector plates 8 has trouble welding to the cylindrical structure. Therefore, the collector plates 8 should be precisely formed corresponding to the rolled poles, and a higher fabrication cost is unavoidable.

### SUMMARY OF THE INVENTION

The present invention has been accomplished under the circumstances in view. It is the main object of the present invention to provide a rechargeable battery fabrication method, which is practical for making a rechargeable battery having excellent discharge efficiency during high current discharging.

To achieve this and other objects of the present invention, the rechargeable battery fabrication method comprises the steps of: (a) preparing a positive pole, a negative pole and two isolation membranes; wherein said positive pole includes an elongated aluminum strip and a positive pole material film partially covering said elongated aluminum strip so that a bare aluminum zone is defined on said positive pole; said negative pole includes an elongated copper strip and a negative pole material film partially covering said copper strip so that a bare copper zone is defined on said negative pole; said negative pole material film has a width larger than or equal to a width of said positive pole material film; said two isolation membranes each have a width larger than or equal to the width of said negative pole material film and smaller than both of the width of said aluminum strip and the width of said copper strip; (b) rolling up said positive pole, one of said isolation membranes, said negative pole and the other one of said isolation membranes, which are orderly arranged in a stack, into a multilayer roll to have said positive pole material film of said positive pole and said negative pole material film of said negative pole be overlapped, the bare aluminum zone of said positive pole and the bare copper zone of said negative pole be respectively positioned at top and bottom sides of said multilayer roll, and said two isolation membranes be respectively positioned corresponding to said positive pole material film of said positive pole and said negative pole material film of said negative pole; wherein the multilayer roll is flattened so that each layer of said bare aluminum zone contacts its adjacent layer(s) of said bare aluminum zone, and each layer of said bare copper zone contacts its adjacent layer(s) of said bare copper zone; (c) welding a first conducting pole to said bare aluminum zone of said positive pole of said multilayer roll to electrically connect each layer of said bare aluminum zone, and welding a second conducting pole to said bare copper zone of said negative pole of said multilayer roll to electrically connect each layer of said bare copper zone; and (d) packaging said multilayer roll in a housing in such a manner that said first conducting pole and said second conducting pole extend out of said housing, and then filling an electrolyte solution in said housing.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic drawing showing the fabrication of a rechargeable battery in accordance with a first embodiment of the present invention (I).

FIG. 2 is a schematic drawing showing the fabrication of a rechargeable battery in accordance with the first embodiment of the present invention (II).

FIG. 3 is a schematic drawing showing the fabrication of a rechargeable battery in accordance with the first embodiment of the present invention (III).

FIG. 4 is a schematic drawing showing the fabrication of a rechargeable battery in accordance with the first embodiment of the present invention (IV).

FIG. 5 is a diagram of 10 C discharge efficiency curves according to the present invention and the prior art.

FIG. 6 is a diagram of 15 C discharge efficiency curves according to the present invention and the prior art.

FIG. 7 is a diagram of 20 C discharge efficiency curves according to the present invention and the prior art.

FIG. 8 is a front view of a positive pole for a rechargeable battery in accordance with a second embodiment of the present invention.

FIG. 9 is a front view of a positive pole for a rechargeable battery in accordance with a third embodiment of the present invention.

### DETAILED DESCRIPTION OF THE PREFERRED EMBODIMENTS

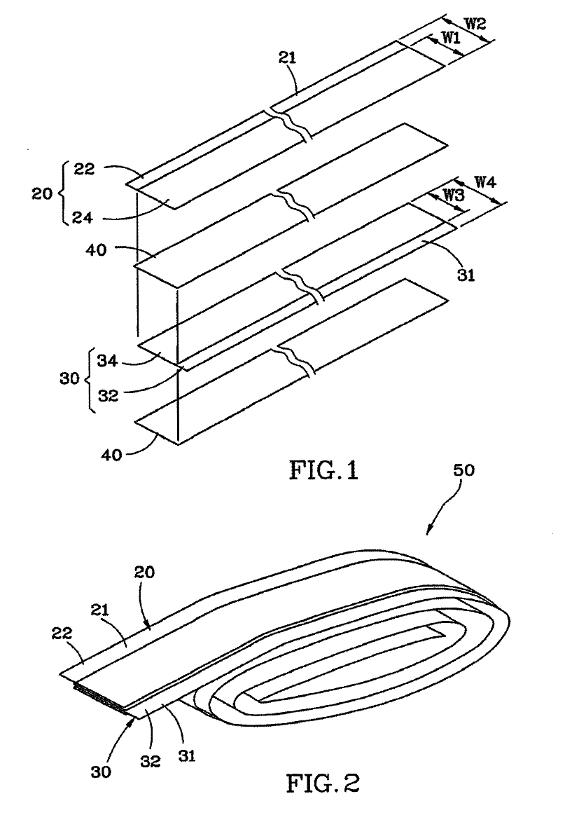

FIGS. 1-4 illustrate the fabrication method of a rechargeable battery 10 in accordance with the first embodiment of the present invention. At first, as shown in FIG. 1, prepare a positive pole 20, a negative pole 30, and two isolation membranes 40. The positive pole 20 comprises a narrow, elongated aluminum strip 22, and a positive pole material film 24 covered on the two opposite surfaces of the aluminum strip 22. The positive pole material film 24 is a LiCoO₂ film, having a width w1 smaller than the width w2 of the aluminum strip 22 so that the positive pole 20 has a bare aluminum zone 21. The negative pole 30 comprises a narrow, elongated copper strip 32, and a negative pole material film 34 covered on the two opposite surfaces of the copper strip 32. The negative pole material film 34 is a MCMB (Mesophase Carbon Micro Beads) film, having a width w3 approximately equal to the width w1 of the positive pole material film 24 and smaller than the width w4 of the copper strip 32 so that the negative pole 30 has a bare copper zone 31. The negative pole material film 34 may be made having its width w3 greater than the width w1 of the positive pole material film 24. The isolation membranes 40 are made of polyethylene, having a width w5 approximately equal to the width w3 of the negative pole material film 34, and smaller than both of the width w2 of the aluminum strip 22 or the width w4 of the copper strip 32. The isolation membranes 40 may be made having their width w5 greater than the width w3 of the negative pole material film 34. Further, the positive pole 20, the negative pole 30 and the two isolation membranes 40 are approximately equal in length.

Alternatively the positive pole material film 24 may be made of any of a variety of other equivalent materials such as lithiated oxide, lithiated sulfide, lithiated selenide, lithiated telluride, lithium-iron-phosphorus oxide, lithium-vanadium-phosphorus oxide of vanadium, titanium, chromium, copper, molybdenum, niobium, iron, nickel, cobalt, manganese or a mixture thereof. Alternatively, the negative pole material film 34 may be made of any of a variety of other equivalent materials such as Mesophase Carbon Micro Beads (MCMB), Vapor-Grown Carbon Fiber (VGCF), Carbon Nanotube (CNT), coke, carbon black, graphite, acetylene black, carbon fiber, vitreous carbon or a mixture thereof. Alternatively, the isolation membranes 40 may be made of polypropylene or polyether.

Thereafter, as shown in FIG. 2, roll up the positive pole 20, one of the isolation membranes 40, the negative pole 30 and the other on of the isolation membranes 40, which are orderly arranged in a stack, into a multilayer roll 50 to have said positive pole material film 24 of said positive pole 20 and said negative pole material film 34 of said negative pole 30 be overlapped. The bare aluminum zone 21 of the positive pole 20 and the bare copper zone 31 of the negative pole 30 are respectively positioned at two opposite (top and bottom) sides of said multilayer roll 50. The two isolation membranes 40 are respectively positioned corresponding to the positive pole material film 24 of the positive pole 20 and the negative pole material film 34 of the negative pole 30 to isolate the positive pole material film 24 from the negative pole material film 34. Alternatively, the sequence of the layers in the multilayer roll 50 can be so arranged with one isolation membrane 40, the positive pole 20, the other one of the isolation membranes 40 and the negative pole 30. The multilayer roll is then flattened so that each layer of said bare aluminum zone contacts its adjacent layer(s) of said bare aluminum zone, and that each layer of said bare copper zone contacts its adjacent layer(s) of said bare copper zone.

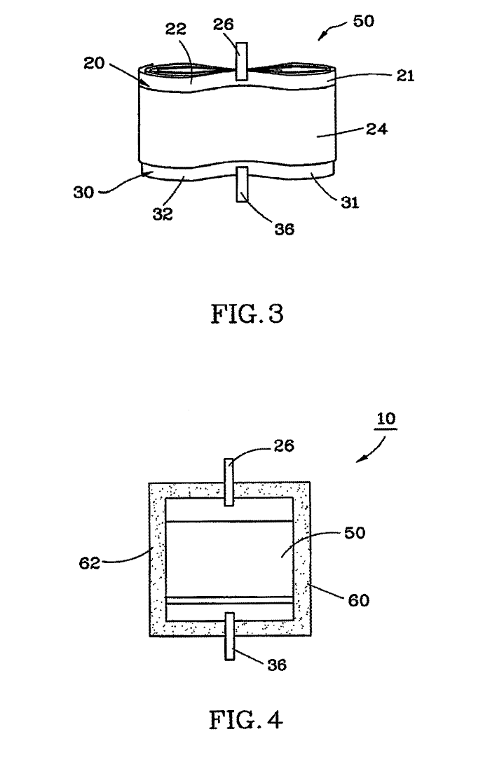

Thereafter, as shown in FIG. 3, weld a first conducting pole 26 to the bare aluminum zone 21 of the positive pole 20 of the multilayer roll 50 to electrically connect each layer of the bare aluminum zone 21 of the positive pole 20, and weld a second conducting pole 36 to the bare copper zone 31 of the negative pole 30 of the multilayer roll 50 to electrically connect each layer of the bare copper zone 31 of the negative pole 30. Preferably, the first conducting pole is welded to said bare aluminum zone at a middle portion of the bare aluminum zone in a width direction, and the second conducting pole is welded to said bare copper zone at a middle portion of the bare copper zone in a width direction. Thus the conducting poles can be welded to the bare aluminum/copper zones more easily while maintaining the discharge efficiency.

At final, as shown in FIG. 4, package the multilayer roll 50 in a housing 60, and then fill an electrolyte solution 62 in the housing 60. After sealing of the housing 60, the desired rechargeable battery is thus obtained, and the first conducting pole 26 and the second conducting pole 36 extend out of the housing 60. According to this embodiment, the electrolyte solution 62 is 1.5M LiPF₆ (lithium hexafluorophosphate). Alternatively, LiBF₄, LiAsF₆, LiSbF₆, LiC10₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, LiB(C₂O₄)₂ or a mixture thereof can be adopted as electrolyte solution 62. The concentration of the electrolyte in the electrolyte solution 62 can be 1.1-2.0M. The solvent for the electrolyte solution 62 is comprised by volume of 30% ethylene carbonates, 20% propylene carbonates, and 50% propyl acetate. Actually, the solvent can be prepared from ethylene carbonates, propylene carbonates, butylene carbonates, dipropyl carbonates, acid anhydrides, n-methylpyrrolidone, n-methyl acetamide, n-methyl formamide, dimethyl formamide, .gamma.-butyrolactone, acetonitrile, dimethyl sulfoxide, dimethyl sulfite, vinylene carbonate (VC), 1,2-diethoxyethane, 1,2-dimethoxyethane, 1,2-dibutoxyethane, tetrahydrofuran, 2-methyl tetrahydrofuran, propylene oxide, methyl acetate, ethyl acetate, propyl acetate, methyl butyrate, ethyl butyrate, methyl propionate, ethyl propionate, dimethyl carbonate (DMC), diethyl carbonate (DEC), ethyl methyl carbonate (EMC), or a mixture thereof.

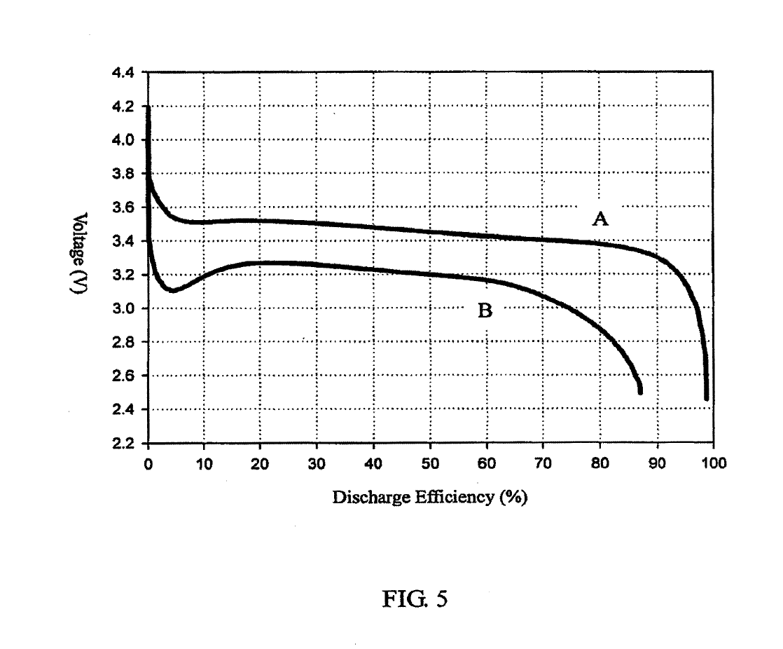

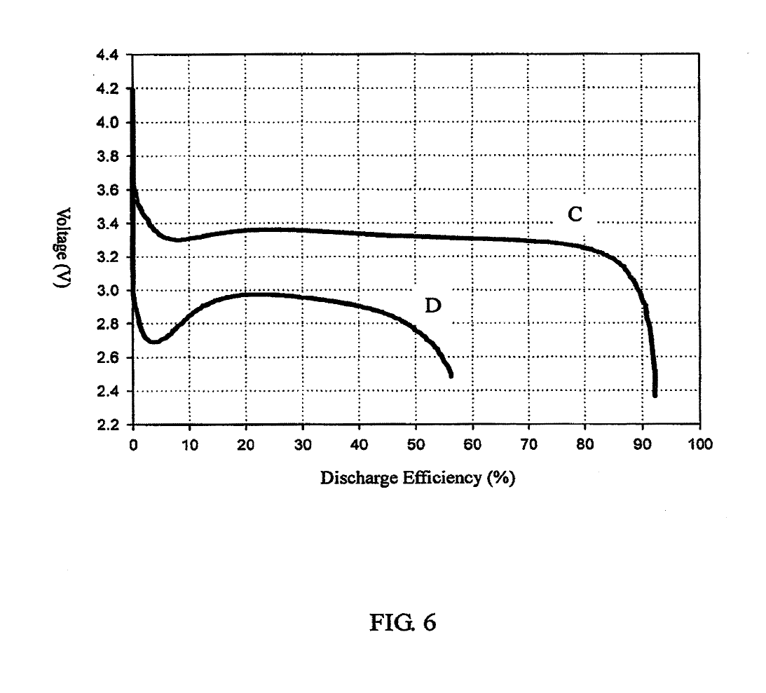

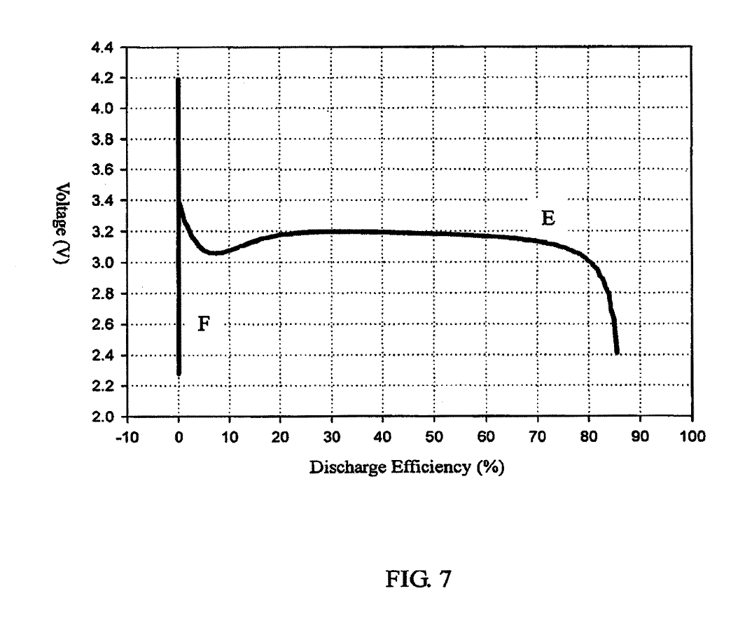

Because the first conducting pole 26 of the positive pole 20 is electrically connected to each layer of the bare aluminum zone 21 and the second conducting pole 36 of the negative pole 30 is electrically connected to each layer of the bare copper zone 31, the moving distance of electrons in both of the positive pole 20 and the negative pole 30 is greatly reduced during discharging of the rechargeable battery 10. The average moving distance is about 2 cm. In a conventional roll type battery, the average moving distance of electrons is about 20 cm. Therefore, the rechargeable battery 10 of the present invention has excellent high current discharge efficiency. When compared with a conventional roll type battery, as shown in FIG. 5, the discharge voltage of the rechargeable battery 10 according to the present invention is maintained at about 3.4-3.5V when discharging at 10 C (see line A) and the discharge voltage of a conventional roll type battery at 10 C is maintained at about 3.2V (see line B). The discharge efficiency of the rechargeable battery 10 of the present invention is over 90%, obviously superior to the prior art. As shown in FIG. 6, the discharge voltage of the rechargeable battery 10 according to the present invention is maintained at about 3.3V when discharging at 15 C (see line C) and the discharge voltage of a conventional roll type battery at 15 C is maintained below 3V (see line D). The discharge efficiency of the rechargeable battery 10 of the present invention is about 90%, which is obviously superior to the discharge efficiency of the prior art (about 50%). As shown in FIG. 7, the discharge voltage of the rechargeable battery 10 according to the present invention is maintained at about 3.2V when discharging at 20 C (see line E) and the discharge efficiency of the rechargeable battery 10 of the present invention is about 80%. A conventional roll type battery cannot discharge under the same situation (see line F).

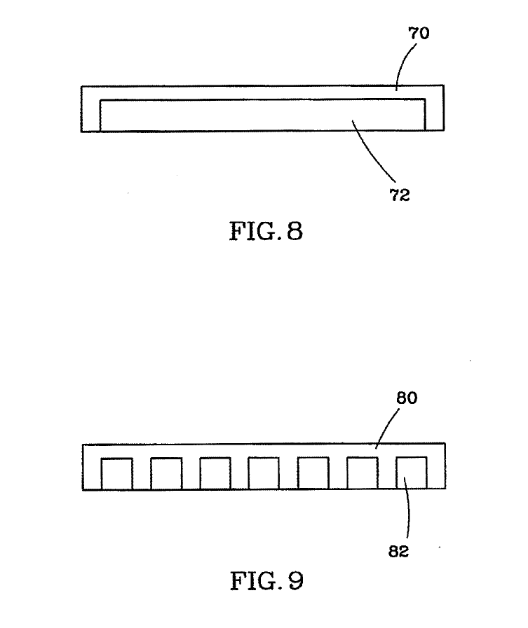

Based on the spirit and scope of the invention, the positive pole material film can simply be coated on one of the two surfaces of the aluminum strip. Similarly, the negative pole material film can simply be coated on one of the two surfaces of the copper strip provided that the negative pole material film faces the positive pole material film. Further, the positive pole material film and the negative pole material film may be respectively coated on the aluminum strip and the copper strip to show any of a variety of patterns. FIG. 8 is a front view of a positive pole 70 for a rechargeable battery in accordance with the second embodiment of the present invention. According to this second embodiment, the positive pole material film 72 extends along one long side of the positive pole 70, having its two ends spaced from the two opposite short sides of the positive pole 70 at a distance. FIG. 9 is a front view of a positive pole 80 for a rechargeable battery in accordance with the third embodiment of the present invention. According to this third embodiment, the positive pole material film 82 shows a parallel pattern.

What is claimed is:

1. A rechargeable battery fabrication method comprising the steps of:
(a) preparing a positive pole, a negative pole and two isolation membranes;
wherein said positive pole includes an elongated aluminum strip and a positive pole material film partially covering said elongated aluminum strip so that a bare aluminum zone is defined on said positive pole; said negative pole includes an elongated copper strip and a negative pole material film partially covering said copper strip so that a bare copper zone is defined on said negative pole; said negative pole material film has a width larger than or equal to a width of said positive pole material film; said two isolation membranes each have a width larger than or equal to the width of said negative pole material film and smaller than both of the width of said aluminum strip and the width of said copper strip;
(b) rolling up said positive pole, one of said isolation membranes, said negative pole and the other one of said isolation membranes, which are orderly arranged in a stack, into a multilayer roll to have said positive pole material film of said positive pole and said negative pole material film of said negative pole be overlapped, the bare aluminum zone of said positive pole and the bare copper zone of said negative pole be respectively positioned at top and bottom sides of said multilayer roll, and said two isolation membranes be respectively positioned corresponding to said positive pole material film of said positive pole and said negative pole material film of said negative pole; wherein the multilayer roll is flattened so that each layer of said bare aluminum zone contacts its adjacent layer(s) of said bare aluminum zone, and each layer of said bare copper zone contacts its adjacent layer(s) of said bare copper zone;
(c) welding a first conducting pole to said bare aluminum zone of said positive pole of said multilayer roll to electrically connect each layer of said bare aluminum zone, and welding a second conducting pole to said bare copper zone of said negative pole of said multilayer roll to electrically connect each layer of said bare copper zone; and
(d) packaging said multilayer roll in a housing in such a manner that said first conducting pole and said second conducting pole extend out of said housing, and then filling an electrolyte solution in said housing.

2. The rechargeable battery fabrication method as claimed in claim 1, wherein the first conducting pole is welded to said bare aluminum zone at a middle portion of the bare aluminum zone in a width direction, and the second conducting pole is welded to said bare copper zone at a middle portion of the bare copper zone in a width direction.

3. The rechargeable battery fabrication method as claimed in claim 1, wherein said positive pole material film is made of one or more materials selected from the group consisting of lithiated oxide, lithiated sulfide, lithiated selenide, lithiated telluride, lithium-iron-phosphorus oxide, lithium-vanadium-phosphorus oxide of vanadium, titanium, chromium, copper, molybdenum, niobium, iron, nickel, cobalt or manganese, and a mixture thereof.

4. The rechargeable battery fabrication method as claimed in claim 1, wherein said negative pole material film is made of one or more materials selected from the group consisting of mesophase carbon micro beads, vapor-grown carbon fiber, carbon nanotube, coke, carbon black, graphite, acetylene black, carbon fiber, vitreous carbon, and a mixture thereof.

5. The rechargeable battery fabrication method as claimed in claim 1, wherein said electrolyte solution comprises an electrolyte selected from the group consisting of LiPF₆, LiBF₄, LiAsF₆, LiSbF₆, LiC10₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, LiB(C₂O₄)₂, and a mixture thereof.

6. The rechargeable battery fabrication method as claimed in claim 1, wherein said electrolyte solution comprises a solvent selected from the group consisting of ethylene carbonates, propylene carbonates, butylene carbonates, dipropyl carbonates, acid anhydrides, n-methylpyrrolidone, n-methyl acetamide, n-methyl formamide, dimethyl formamide, .gamma.-butyrolactone, acetonitrile, dimethyl sulfoxide, dimethyl sulfite, vinylene carbonate, 1,2-diethoxyethane, 1,2-dimethoxyethane, 1,2-dibutoxyethane, tetrahydrofuran, 2-methyl tetrahydrofuran, propylene oxide, methyl acetate, ethyl acetate, propyl acetate, methyl butyrate, ethyl butyrate, methyl propionate, ethyl propionate, dimethyl carbonate, diethyl carbonate, ethyl methyl carbonate, and a mixture thereof.
